(19) United States
(12) Patent Application Publication
(10) Pub. No.: US 2014/0084131 A1
(43) Pub. Date: Mar. 27, 2014

(54) APPARATUS INCLUDING MULTI-JOINTED ARM AND GRAVITY COMPENSATION METHOD

(71) Applicants: Hyun-Sik SIM, Yongin-si (KR); Yongjae KIM, Seoul (KR); Narae LEE, Seongnam-si (KR); Youn Baek LEE, Suwon-si (KR)

(72) Inventors: Hyun-Sik SIM, Yongin-si (KR); Yongjae KIM, Seoul (KR); Narae LEE, Seongnam-si (KR); Youn Baek LEE, Suwon-si (KR)

(21) Appl. No.: 13/955,550

(22) Filed: Jul. 31, 2013

(30) Foreign Application Priority Data
Sep. 26, 2012 (KR) 10-2012-0107191

(51) Int. Cl. B25J 19/00

(52) U.S. Cl. CPC B25J 19/002
USPC 248/648

(57) ABSTRACT

The present inventive concepts relate to an apparatus having a multi-jointed arm. The apparatus having a multi-jointed arm may include a body; a multi-jointed arm having a first link rotatably combined with the body at a first joint and a second link rotatably combined with the first link at a second joint; and a compensator generating a compensation moment cancelling out a moment being generated by a weight of the multi-jointed arm. The compensator includes a compensation load generating the compensation moment, and a compensation link connecting the compensation load and the multi-jointed arm so that the compensation load and the multi-jointed arm are on opposite sides of the first joint.

### CROSS-REFERENCE TO RELATED APPLICATIONS

This U.S. non-provisional patent application claims priority under 35 U.S.C. §119 of Korean Patent Application No. 10-2012-0107191, filed on Sep. 26, 2012, the entire contents of which are hereby incorporated by reference.

### BACKGROUND

1. Field

The present inventive concepts herein relates to apparatuses including a multi-jointed arm and gravity compensation methods.

2. Description of the Related Art

Typically, robots are used to assist workers in an industrial site or to perform work that it is difficult for a worker to directly perform. Recently, a robot providing life convenience at home, a wearable robot that may assist a person's exercise has been being developed.

An actuator providing power to a robot may be provided to a joint of the robot. A workload due to weight of a workpiece and a dead load due to deadweight of a robot are applied to a robot. It is selected that an actuator has a torque corresponding to a work-load and a dead load. Among torques provided by an actuator, a torque corresponding to a dead load is not used in work that a robot performs but is wasted.

### SUMMARY

At least one example embodiment of the inventive concepts provide an apparatus having a multi-jointed arm. The apparatus having a multi-jointed arm may include a body, a multi-jointed arm that may have a first link rotatably combined with the body at a first joint and a second link rotatably combined with the first link at a second joint, and a compensator that is configured to generate a compensation moment that reduces a moment being generated by a weight of the multi-jointed arm. The compensator may include a compensation load configured to generate the compensation moment, and a compensation link that connects the compensation load and the multi-jointed arm such that the compensation load and the multi-jointed arm are on opposite sides of the first joint.

At least one example embodiment of the inventive concepts provide a gravity compensation method of reducing or cancelling out a moment being applied to a multi-jointed arm. The multi-jointed arm includes a first link rotatably combined with a body at a first joint and a second link rotatably combined with the first link at a second joint. The method includes a compensator that generates a compensation moment in an opposite direction to a moment caused by a weight of the multi-joint arm. A moment caused by the weight of the multi-joint arm may be reduced or cancelled out by a compensation load.

### BRIEF DESCRIPTION OF THE FIGURES

Example embodiments of the inventive concepts will be described below in more detail with reference to the accompanying drawings. The various embodiments of the inventive concepts may, however, be embodied in different forms and should not be constructed as limited to the embodiments set forth herein. Rather, these embodiments are provided so that this disclosure will be thorough and complete, and will fully convey the scope of the inventive concepts to those skilled in the art. Like numbers refer to like elements throughout.

FIG. 1 is a drawing illustrating an apparatus having a multi-jointed arm, according to an example embodiment of the inventive concepts.

FIG. 2 is a schematic diagram of the multi-jointed arm of FIG. 1, according to an example embodiment of the inventive concepts.

FIG. 3 is a drawing illustrating an equivalent model of FIG. 2 according to an example embodiment of the inventive concepts.

FIG. 4 is a drawing illustrating a location to which a compensation load is applied, according to an example embodiment of the inventive concepts.

FIGS. 5 and 6 are drawings illustrating a state that a compensation load is applied to the multi-jointed arm of FIG. 1, according to an example embodiment of the inventive concepts.

FIG. 7 is a drawing illustrating a multi-jointed arm having a compensation unit, according to an example embodiment of the inventive concepts inventive concepts.

FIG. 8 is a schematic diagram of the multi-jointed arm of FIG. 7, according to an example embodiment of the inventive concepts.

FIGS. 9 and 10 are drawings illustrating an equivalent model of the first and second links of FIG. 7, according to an example embodiment of the inventive concepts.

FIG. 11 is a drawing illustrating a multi-jointed arm having a compensation unit, according to an example embodiment of the inventive concepts.

FIG. 12 is a schematic diagram of the multi-jointed arm of FIG. 11, according to an example embodiment of the inventive concepts.

FIG. 13 is a drawing illustrating a multi-jointed arm having a compensation unit, according to an example embodiment of the inventive concepts.

FIG. 14 is a drawing illustrating an equivalent model of FIG. 13, according to an example embodiment of the inventive concepts.

FIG. 15 is a drawing illustrating an equivalent model of FIG. 14, according to an example embodiment of the inventive concepts.

### DETAILED DESCRIPTION OF THE EMBODIMENTS

Embodiments of inventive concepts will be described more fully hereinafter with reference to the accompanying drawings, in which embodiments of the invention are shown. The inventive concepts may, however, be embodied in many different forms and should not be construed as limited to the embodiments set forth herein. Rather, these embodiments are provided so that this disclosure will be thorough and complete, and will fully convey the scope of the inventive concepts to those skilled in the art. In the drawings, the size and relative sizes of layers and regions may be exaggerated for clarity. Like numbers refer to like elements throughout.

It will be understood that, although the terms ‘first’, ‘second’, ‘third’, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concepts. For example, a first element may be designated as a second element, and similarly, a second element may be designated as a first element without departing from the teachings of the inventive concepts.

Unless otherwise defined, all terms (including technical and scientific terms) used herein have the same meaning as commonly understood by one of ordinary skill in the art to which this inventive concepts belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. As used herein, the term “and/or” includes any and all combinations of one or more of the associated listed items. Expressions such as “at least one of,” when preceding a list of elements, modify the entire list of elements and do not modify the individual elements of the list.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

If an embodiment is differently realizable, a specified operation order may be differently performed from a described order. For example, two consecutive operations may be substantially simultaneously performed, or in an order opposite to the described order.

Variations from the shapes of the illustrations as a result, for example, of manufacturing techniques and/or tolerances, are to be expected. Thus, embodiments of the inventive concepts should not be construed as limited to the particular shapes of regions illustrated herein but are to include deviations in shapes that result, for example, from manufacturing.

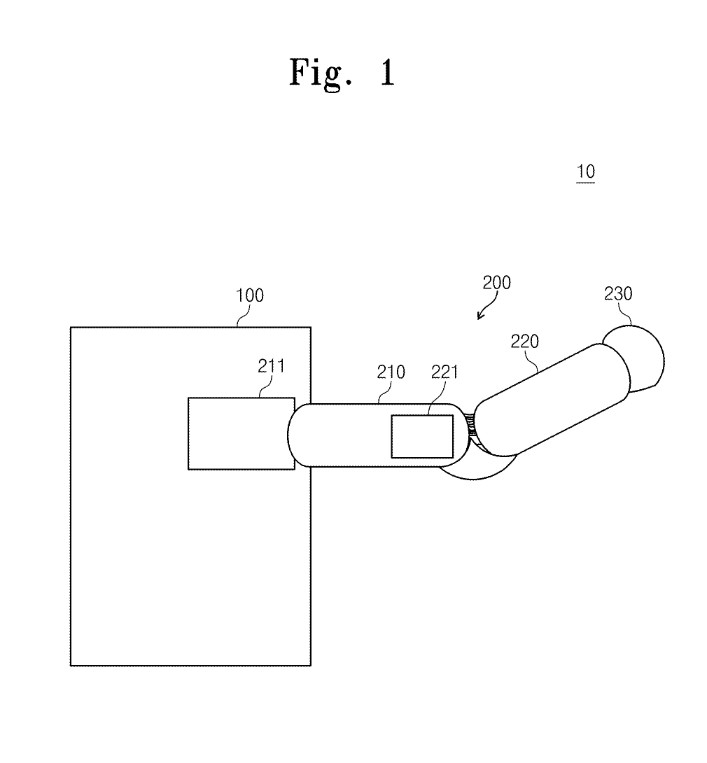

FIG. 1 is a drawing illustrating an apparatus having a multi-jointed arm, according to an example embodiment of the inventive concepts.

An apparatus 10 having a multi-jointed arm may be any type of robot or other like mechanical agent, such as a humanoid robot, a medical robot, a robot of machine tailored for a particular industrial use, a rehabilitation assistance apparatus, a robot suit, a service robot, or a combination thereof. The apparatus 10 having multi-jointed arm may also be a home robot or pet robot assisting a person's life at home or in other like residential settings.

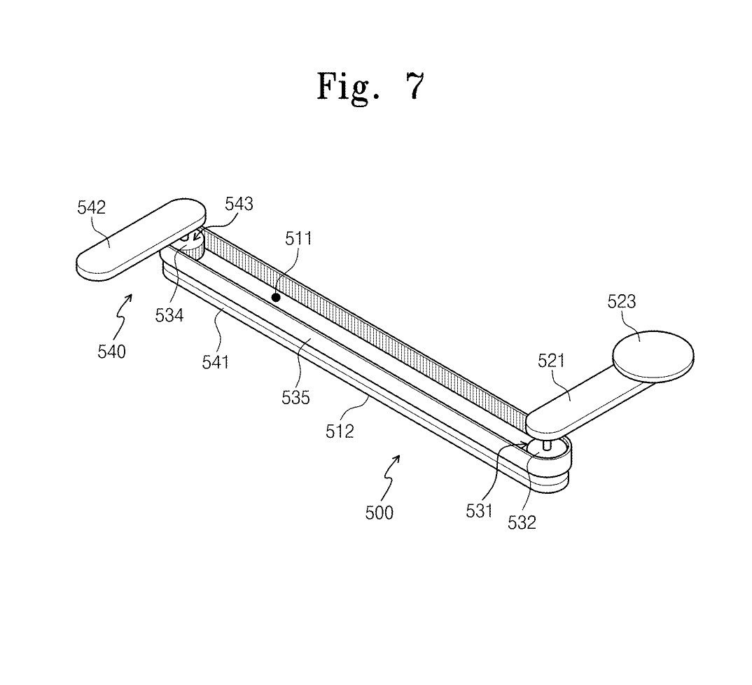

Referring to FIG. 1, the apparatus 10 having a multi-jointed arm includes a body 100, a multi-jointed arm 200 and a compensation unit (as shown at 540 of FIG. 7).

The body 100 is provided as a frame of the robot or apparatus described above. In various embodiments, a plurality of multi-jointed arms 200 (not shown) may be attached or otherwise provided to the body 100. The multi-jointed arm 200 includes an upper arm 210 and a lower arm 220. The upper arm 210 is rotatably combined with the body 100. A first actuator 211 is provided to the body 100 or the upper arm 210. The first actuator 211 provides power that can rotate the upper arm 210 with respect to the body 100. The lower arm 220 is rotatably combined with the upper arm 210. In various embodiments, a second actuator 221 is provided to the upper arm 210 (as shown) or may be provided to the lower arm 220 (not shown). The second actuator 221 provides power that can rotate the lower arm 220 with respect to the upper arm 210. The actuators 211 and 221 may be provided as an electrical motor or a hydraulic cylinder. A working member 230 is provided to an end portion of the lower arm 220. The working member 230 may be one or more different apparatuses according to use of the multi-jointed arm 200. For example, the working member 230 may be a robotic hand, a paint gun, a drill, a cinematograph camera, a welding machine, a sensor, and other like apparatuses.

A compensation unit 540 (as shown in FIG. 7) generates a compensation moment. Moment due to a weight of the multi-jointed arm 200 is applied to the multi-jointed arm 200. The moment increases torque being required in the actuators 211 and 221. The compensation moment being generated by the compensation unit 540 cancels out the moment due to the weight of the multi-jointed arm 200, thereby reducing the torque being required in the actuators 211 and 221. Thus, the compensation unit 540 may be provided in order to reduce a size of the actuators 211 and 221 thereby reducing the energy consumption of the actuators 211 and 221.

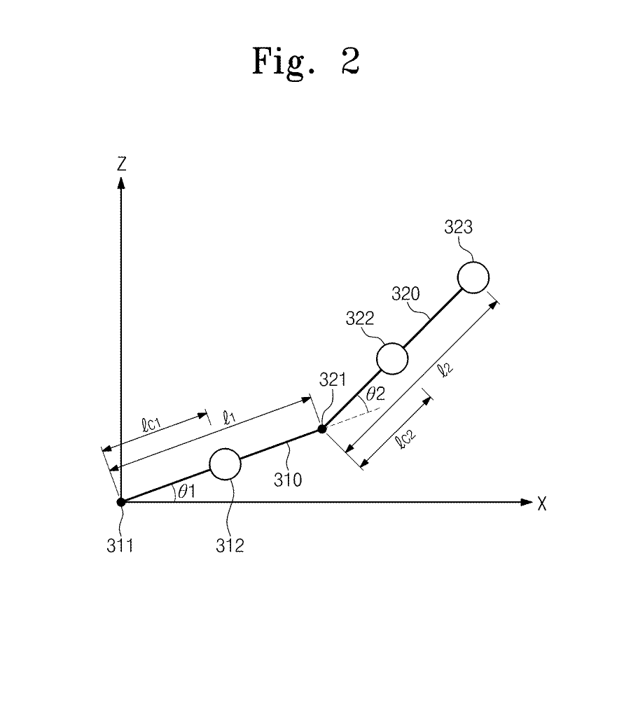

FIG. 2 is a schematic diagram of the multi-jointed arm of FIG. 1, according to an example embodiment of the inventive concepts.

Referring to FIG. 2, the upper arm 210 is represented by first link 310 and the lower arm 220 is represented by second link 320. A portion that the first link 310 is combined with the body 100 to become a first joint 311 and a portion that the second link 320 is combined with the first link 310 to become a second joint 321. It may be assumed that a mass of the first link 310 is gathered on a first center of gravity 312 on the first link 310. It may be assumed that a mass of the second link 320 is gathered on a second center of gravity 322 on the second link 320. The working member 230 is represented by mass 323 located at an end portion of the second link 320.

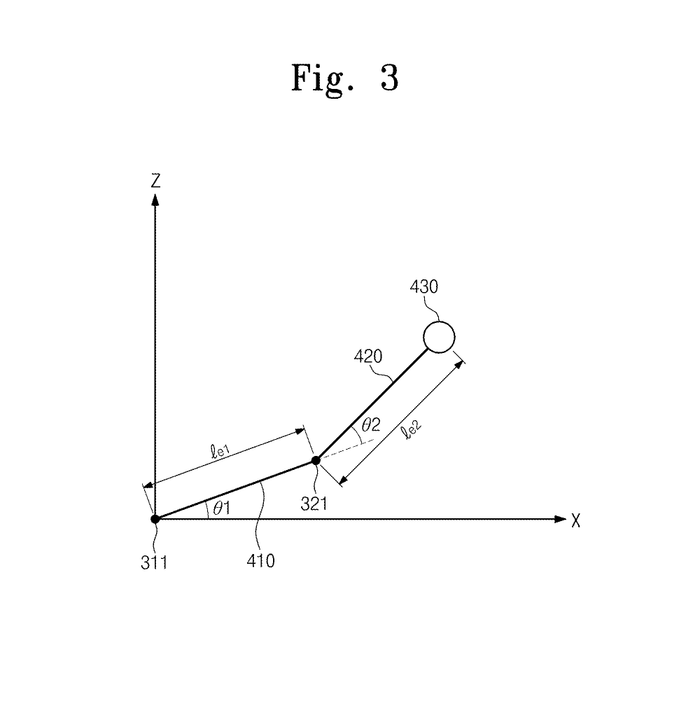

FIG. 3 is a drawing illustrating an equivalent model of FIG. 2, according to an example embodiment of the inventive concepts. The equivalent model, as shown in FIG. 3, may be a simpler or less complex version of the schematic diagram as shown in FIG. 2. The equivalent model of FIG. 2 may be used to simplify calculations or to aid in analysis.

Referring to FIG. 3, the multi-jointed arm 200 of FIG. 1 may be converted into an equivalent model having a first equivalent link 410, a second equivalent link 420 and equivalent mass 430. The first equivalent link 410 and the second equivalent link 420 are virtual links having no mass, or a mass equal to zero. An angle between the first equivalent link 410 and the body 100 is the same as the angle between the first link 310 and the body 100. The second equivalent link 420 is rotated with respect to the first equivalent link 410. An angle between the second equivalent link 420 and the first equivalent link 410 is the same as the angle between the second link 320 and the first link 310. The second equivalent link 420 and the second link 320 rotate at the same angle. The equivalent mass 430 is the same as the sum of mass of the first link 310, mass of the second link 320 and mass of the working member 230. The equivalent mass 430 is located at an end portion of the second link 320. In a mathematical formula below, a length of the first link 310 is called 11, a length of the second link 320 is called 12, mass of the first link 310 is called mₗᵢₙₖ₁, mass of the second link 320 is called mₗᵢₙₖ₂ and mass of the working member 230 is called m_{end}. A distance between the first joint 311 and the first center 312 of gravity is called l_{c1} and a distance between the second joint 321 and the second center 322 of gravity is called l_{c2}. A length of the first equivalent link 410 is called lₑ₁ and a length of the second equivalent link 420 is called lₑ₂ and magnitude of the equivalent mass 430 is called mₑ.

Moment of z-axis direction being applied to the multi-jointed arm 200 using the first joint 311 as a rotation axis may be represented by a mathematical formula 1.

m_{Link1}l_{c1} sin θ₁+m_{Link2}{l₁ sin θ₁+l_{c2} sin(θ₁+θ₂)}+m_{End}{l₁ sin θ₁+l₂ sin(θ₁+θ₂)}=mₑz [mathematical formula 1]

θ₁ is an angle between the first link 310 and an x-axis and θ₂ is an angle between the second link 320 and the first link 310, z is a distance between the first joint 311 and the equivalent mass 430 in the equivalent model.

Moment of the x-axis direction being applied to the multi-jointed arm 200 using the first joint 311 as a rotation axis may be represented by a mathematical formula 2.

m_{Link1}l_{c1} cos θ₁+m_{Link2}{l₁ cos θ₁+l_{c2} cos(θ₁+θ₂)}+m_{End}{l₁ cos θ₁+l₂ cos(θ₁+θ₂)}=mₑx [mathematical formula 2]

x is a distance on an x-axis between the first joint 311 and the equivalent mass 430 in the equivalent model.

A relation between the equivalent mass, the mass of the first link 310, the mass of the second link 320 and the mass of the working member 230 may be represented by a mathematical formula 3.

mₑ=m_{Link1}+m_{Link2}=m_{End} [mathematical formula 3]

In the case that the first link 310 is located on the x-axis, θ₁ becomes 0°. When θ₁ is 0°, the mathematical formula 1 may be simplified by mathematical formula 4.

$$z = \frac{{m}_{Link 2} {l}_{c 2} + {m}_{End} {l}_{2}}{{m}_{e}} sin {θ}_{2} \qquad [ mathematical formula 4 ]$$

When θ₂ is 0°, the mathematical formula 2 may be simplified like a mathematical formula 5.

$$x = \frac{{m}_{Link 1} {l}_{c 1} + {m}_{Link 2} {l}_{1} + {m}_{End} {l}_{1}}{{m}_{e}} + \frac{{m}_{Link 2} {l}_{c 2} + {m}_{End} {l}_{2}}{{m}_{e}} cos {θ}_{2}$$

Coefficient parts of trigonometrical function in the mathematical formulas 4 and 5 may be defined by a mathematical formula 6.

$$\frac{{m}_{Link 2} {l}_{c 2} + {m}_{End} {l}_{2}}{{m}_{e}} = A \qquad [ mathematical formula 6 ]$$

A constant part of the mathematical formula 5 may be defined by a mathematical formula 7.

$$\frac{{m}_{Link 1} {l}_{c 1} + {m}_{Link 2} {l}_{1} + {m}_{End} {l}_{1}}{{m}_{e}} = B \qquad [ mathematical formula 7 ]$$

If substituting the mathematical formulas 6 and 7 into the mathematical formulas 4 and 5, the mathematical formulas 4 and 5 may be simplified as follows.

z=A sin θ₂ [mathematical formula 8]

x=B+A cos θ₂ [mathematical formula 9]

If arranging the mathematical formulas 8 and 9 using a square formulation of trigonometrical function, they may be represented by a mathematical formula 10.

z²+(x−B)²=A² [mathematical formula 10]

The mathematical formula 10 represents a circle with a radius of A. The center of the circle is located at a distance B from the first joint 311 in the x-axis direction.

In the equivalent model, if θ₁ is 0°, the first equivalent link 410 is located on the x-axis. The second equivalent link 420 is rotated at an end portion of the first equivalent link 410. The path along which the equivalent mass 430 moves is a circle of which a radius is a length of the second equivalent link 420. Thus, a distance between the center of the circle which is the path of the equivalent mass 430 and the first joint 311 is a length of the first equivalent link 410 and a radius of the circle is the length of the second equivalent link 420. Referring to the mathematical formula 10, a length of the first equivalent link 410 and a length of the second equivalent link 420 are as follows.

$$\begin{matrix}{l}_{e 1} = B = \frac{{m}_{Link 1} {l}_{c 1} + {m}_{Link 2} {l}_{1} + {m}_{End} {l}_{1}}{{m}_{e}} & [ mathematical formula 11 ] \\ {l}_{e 2} = A = \frac{{m}_{Link 2} {l}_{c 2} + {m}_{End} {l}_{2}}{{m}_{e}} & [ mathematical formula 12 ]\end{matrix}$$

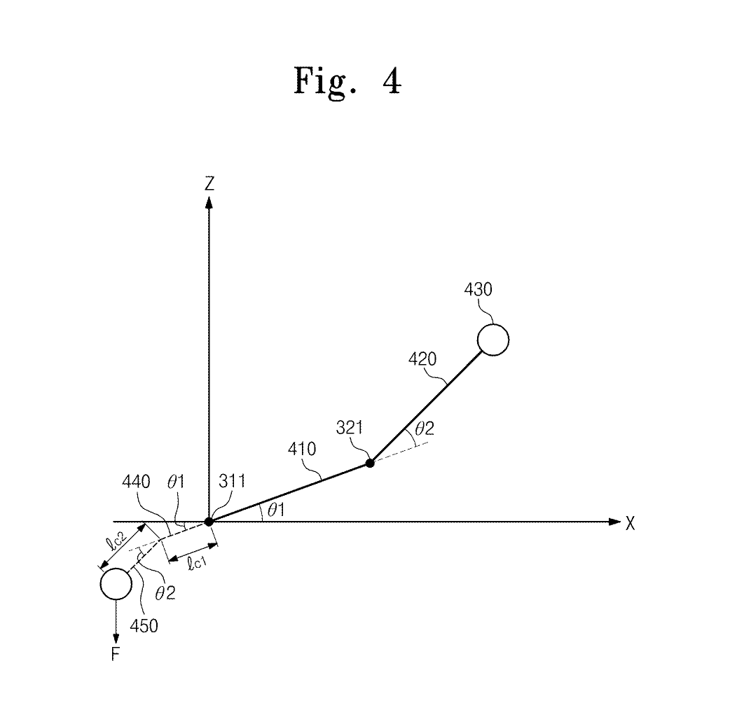

FIG. 4 is a drawing illustrating a location to which a compensation load is applied, according to an example embodiment of the inventive concepts.

Referring to FIG. 4, first and second virtual lines 440 and 450 and the multi-jointed arm 200 are on opposite sides of the first joint 311. A phase difference between the first virtual line 440 and the first link 310 and between the first virtual line 440 and the first equivalent link 410 is 180°. For example, if the first link 310 and the first equivalent link 410 make an angle of θ₁ with the x-axis, the first virtual line 440 makes an angle of 180°+θ₁ with the x-axis. The first virtual line 440 rotates at the same angle as the first link 310 and the first equivalent link 410 using the first joint 311 as a rotation axis. Thus, the angle between the first virtual line 440 and the first link 310 and the angle between the first virtual line 440 and the first equivalent link 410 are maintained to be 180°.

The second virtual line 450 rotates at an end portion of the first virtual line 440. An angle between the first virtual line 440 and the second virtual line 450 is the same as the angle between the first link 310 and the second link 320. Thus, the angle between the first virtual line 440 and the second virtual line 450 is the same as the angle between the first equivalent link 410 and the second equivalent link 420. A ratio of a length of the second virtual line 450 to a length of the first virtual line 440 is the same as the ratio of the length of the second equivalent link 420 to the length of the first equivalent link 410. A straight line connecting an end portion of the second virtual line to an end portion of the second equivalent link 420 passes through the first joint 311.

A compensation load (F) is applied to an end portion of the second virtual line 450. The compensation load (F) and the equivalent mass 430 are on opposite sides of the first joint 311. A straight line connecting the compensation load (F) to the equivalent mass 430 passes through the first joint 311. Thus, a moment being generated by the compensation load (F) using the first joint 311 as a rotation axis is applied in an opposite direction to a moment being generated by the equivalent mass 430.

The magnitude of compensation moment is selected so that the moment being generated by the compensation load (F) reduces or cancels out the moment being generated by the equivalent mass 430. For example, the magnitude of compensation moment is selected so that the moment being generated by the compensation load (F) is the same as the moment being generated by the equivalent mass 430. In the case that the moment being generated by the compensation load (F) is the same as the moment being generated by the equivalent mass 430, a mathematical formula 13 is established.

$$\frac{{m}_{e} g}{F} = \frac{{l}_{s 1}}{{l}_{e 1}} = \frac{{l}_{s 2}}{{l}_{e 2}} \qquad [ mathematical formula 13 ]$$

Thus, the magnitude of the compensation load (F) is as follow.

$$F = \frac{{l}_{e 1} {m}_{e} g}{{l}_{s 1}} = \frac{{l}_{e 2} {m}_{e} g}{{l}_{s 2}} \qquad [ mathematical formula 14 ]$$

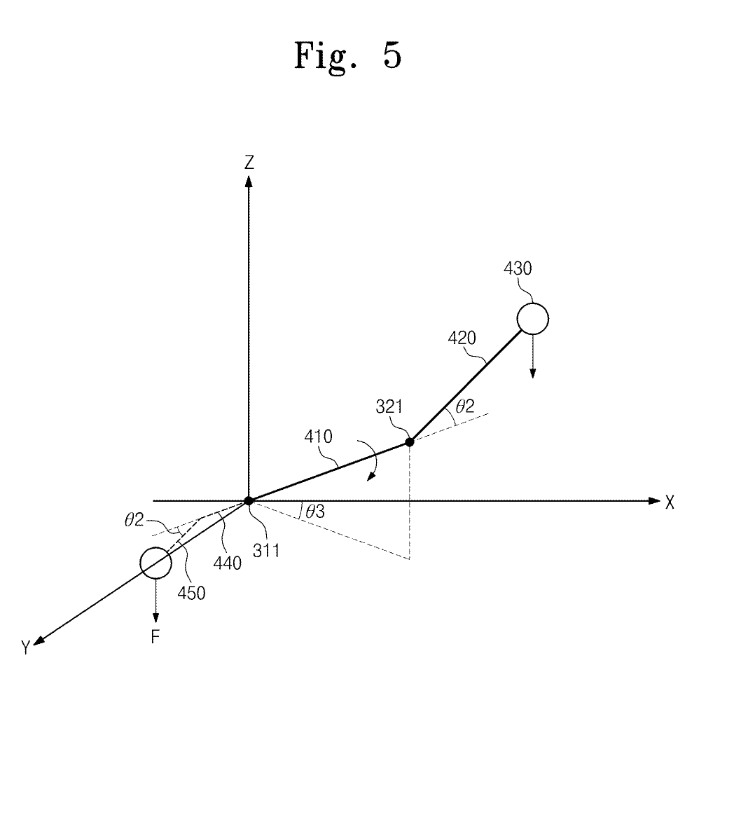

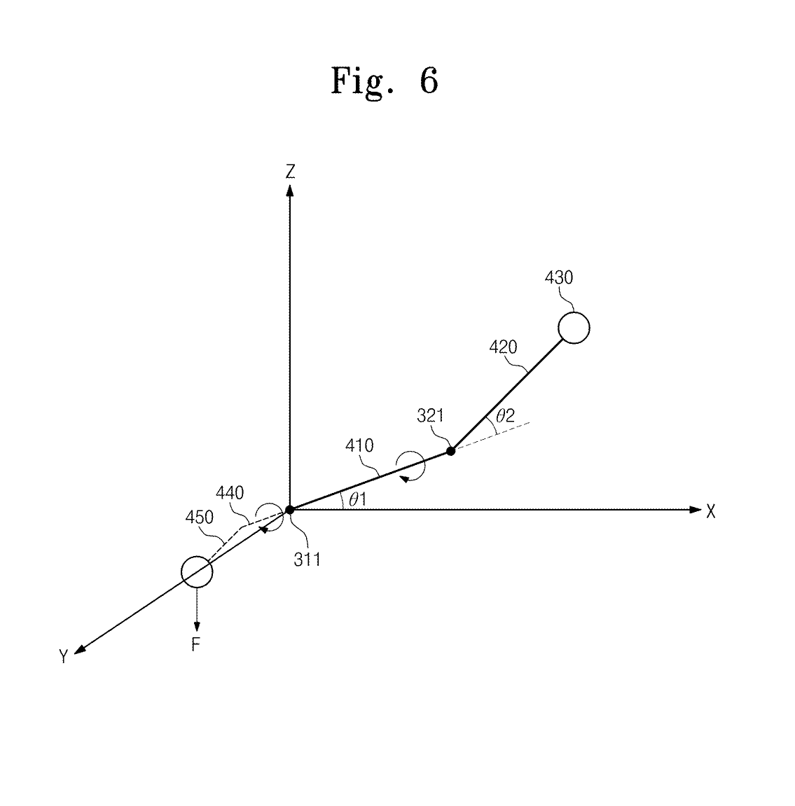

FIGS. 5 and 6 are drawings illustrating a state that a compensation load is applied to the multi-jointed arm of FIG. 1, according to an example embodiment of the inventive concepts.

Referring to FIG. 5, the multi-jointed arm 200 can rotate using a z-axis as a rotation axis. For example, the first link 310 and the first equivalent link 410 may rotate to make an angle of θ₃ with the x-axis. Even in the case that the multi-jointed arm 200 rotates using the z-axis as a rotation axis, the first equivalent link 410, the second equivalent link 420, the first virtual line 440 and the second virtual line 450 are located on the same plane. Thus, even in the case where the first joint 311 rotates using the z-axis as a rotation axis, the moment being generated by the equivalent mass 430 is reduced or cancelled out by the moment generated by the compensation load (F).

Referring to FIG. 6, the second joint 321 can rotate using a length direction of the first link 310 as an axis. For example, the first joint 311 can rotate using a length direction of the first link 310 as an axis. The first link 310 may be provided so that a space between the first joint 311 and the second joint 321 can rotate. If the second joint 321 rotates, the second link 320 rotates in a circular motion using the second joint 321 as a rotation axis. The first virtual line 440 is provided so that it rotates equally to the first link 310. Thus, even if the first link 310 rotates using its length direction as a rotation axis, the first link 310, the second link 320, the first virtual line 440 and the second virtual line 450 are located on the same plane. A Moment (M_{Link}) being applied to the multi-jointed arm 200 on the basis of an axis passing through the first link 310 may be represented by a mathematical formula 15.

M_{Link}=(m_{Link2}l_{c2}+m_{End}l₂)sin θ₂ [mathematical formula 15]

Compensation moment (M_{force}) being applied to the multi-jointed arm 200 by the compensation load (F) on the basis of an axis passing through the first link 310 may be represented by a mathematical formula 16.

M_{force}=(F/g)lₛ₂ sin θ₂=mₑlₑ sin θ₂=(m_{Link2}l_{c2}+m_{End}l₂)sin θ₂=M_{Link} [mathematical formula 16]

Thus, the compensation load reduces or cancels out a moment being generated when the first link 310 rotates using an axis passing through its length direction as a rotation axis. As described above, the first joint 311 of the multi-jointed arm 200 can rotate in a direction perpendicular to an x-y plane and parallel to an x-y plane. The second joint 321 can rotate using a length direction of the first link 310 as an axis. The second link 320 may be provided to rotate with respect to the first joint 311. Thus, the multi-jointed arm 200 may have four degrees of freedom. The compensation load (F) reduces or cancels out a moment being generated by deadweight in the multi-jointed arm 200 of four degrees of freedom.

FIG. 7 is a drawing illustrating a multi-jointed arm having a compensation unit, according to an example embodiment of the inventive concepts.

Referring to FIG. 7, a compensation unit 540 is connected to a multi-jointed arm 500. The multi-jointed arm 500 may include a first link 512 and a second link 521. The first link 512 is rotatably combined with a first joint 511. The second link 521 is rotatably combined with the first link 512. As shown, working member 523 is located on the second link 521. In alternate embodiments, the working member 523 may be omitted (not shown).

The compensation unit 540 includes a first compensation link 541 and a second compensation link 542. The first compensation link 541 extends in an opposite direction to the first link 512 at the first joint 511. The first compensation link 541 and the first link 512 make a straight line. The first compensation link 541 rotates at the same angle as the first link 512 with respect to the first joint 511. For example, an end portion of the first compensation link 541 may be connected to an end portion of the first link 512. The second compensation link 542 is rotatably combined with the first compensation link 541 at a compensation joint 543. An angle between the second compensation link 542 and the first compensation link 541 is the same as the angle between the second link 521 and the first link 512. A compensation load (e.g., 545 of FIG. 9 and 546 of FIG. 10 which will be described later) is located on the second compensation link 542 (not shown). The first compensation link 541 makes a first virtual line from the first joint 511 to the compensation joint 543 (not shown) and the second compensation link 542 makes a second virtual line from the compensation joint 543 to the compensation load (e.g., 544 and 546 of FIG. 10).

The second compensation link 542 rotates in the same direction as the second link 521. For example, a first rotation body 532 may be provided to a second joint 531. The first rotation body 532 rotates together with the second link 521. A second rotation body 534 is provided to the compensation joint 543. The second rotation body 534 rotates in the same direction as the first rotation body 532. For example, the first rotation body 532 and the second rotation body 534 are connected to a location moving member 535. If the first rotation body 532 rotates, the second rotation body 534 connected to the location moving member 535 rotates in the same direction. The second rotation body 534 may have the same radius as the first rotation body 532. An angle at which the second rotation body 534 rotates is the same as an angle at which the first rotation body 532 rotates. The second compensation link 542 rotates at the same angle as the second rotation body 534. Thus, the second link 521 and the second compensation link 542 rotate at the same angle and in the same direction. The location moving member 535 may be provided by a belt.

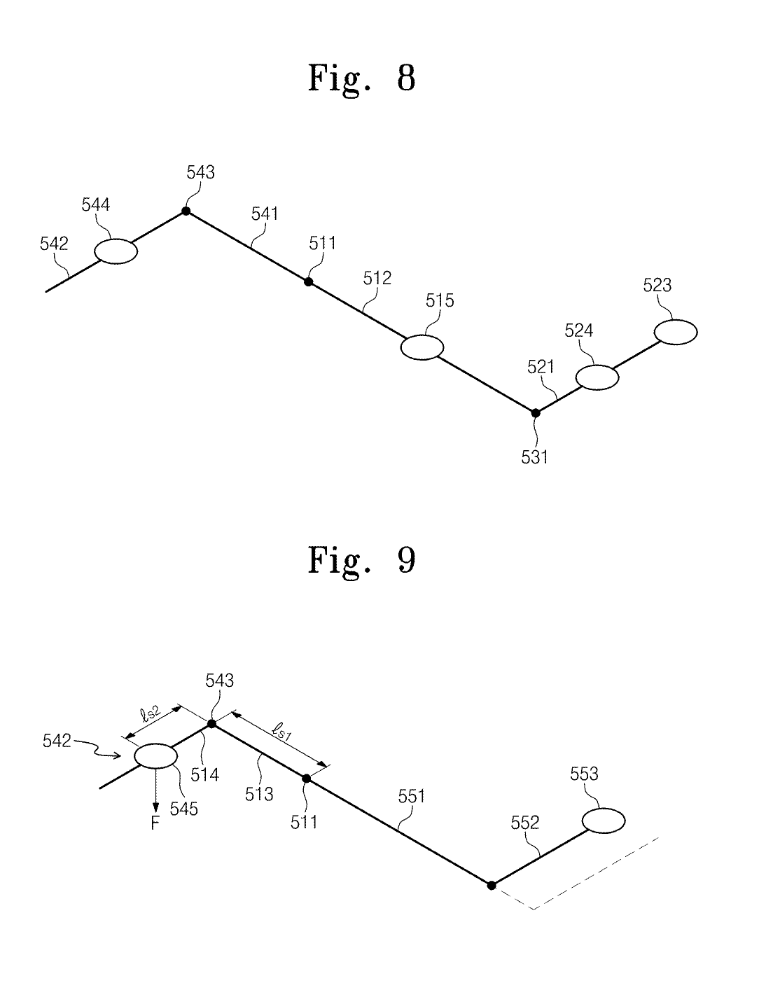

FIG. 8 is a schematic diagram of the multi-jointed arm of FIG. 7, according to an example embodiment of the inventive concepts.

FIG. 7 may be a simplified representation of FIG. 8. A first center of gravity 515 is located on the first link 512 and a second center of gravity 524 is located on the second link 521. The first center of gravity 515 is a center of gravity of the first link 512 and the first compensation link 541. The second center of gravity 524 is a center of gravity of the second link 521. Mass of the working member 523 is located at an end portion of the second link 521. In the case where the working member 523 is omitted, the mass of the working member 523 is also omitted. A third center of gravity 544 is located on the second compensation link 542.

FIGS. 9 and 10 are drawings illustrating an equivalent model of the first and second links of FIG. 7, according to an example embodiment of the inventive concepts.

Referring to FIG. 9, the multi-jointed arm 500 of FIG. 7 may be converted into a virtual equivalent model. A first equivalent link 551, a second equivalent link 552 and equivalent mass 553 are obtained by the processes as described above with respect to FIGS. 1-3. A length of a first virtual line 513, a length of a second virtual line 514 and the magnitude of a compensation load (F) may be obtained through the mathematical formula 13 or the mathematical formula 14, as described above. A length of the second compensation link 542 may be greater than a length of the second virtual line 514. The third center 544 of gravity is located at an end portion of the second virtual line 514. Thus, the third center 544 of gravity is the same as a location of the compensation load 545. The compensation load 545 may be provided by locating additional mass at the third center 544 of gravity. The magnitude of the additional mass may be provided as follows, mₐ represents the magnitude of the additional mass and m₃ represents mass of the second compensation link 542.

$${m}_{a} = \frac{F}{g} - {m}_{3} \qquad [ mathematical formula 17 ]$$

Referring to FIG. 10, a length of the second compensation link 542 is the same as a length of the second virtual line 514. The compensation load 546 is located at an end portion of the second compensation link 542. Mass of the second compensation link 542 is relatively small as compared with the additional mass and thereby it may be ignored. The compensation load 646 may be provided by locating additional mass at an end portion of the second compensation link 542. The magnitude of the additional mass may be provided as follows.

$${m}_{a} = \frac{F}{g} \qquad [ mathematical formula 18 ]$$

As described above, in the case that a location of the additional mass is determined while ignoring the mass of the second compensation link 542, a line connecting an end portion of the second compensation link 542 to an end portion of the second equivalent line 552 does not pass through the first joint 511. If setting a location of the additional mass so that a line connecting an end portion of the second compensation link 542 to an end portion of the second equivalent line 552 is adjacent to the first joint 511, moment due to the equivalent mass 553 may be sufficiently reduced or cancelled out by the additional mass.

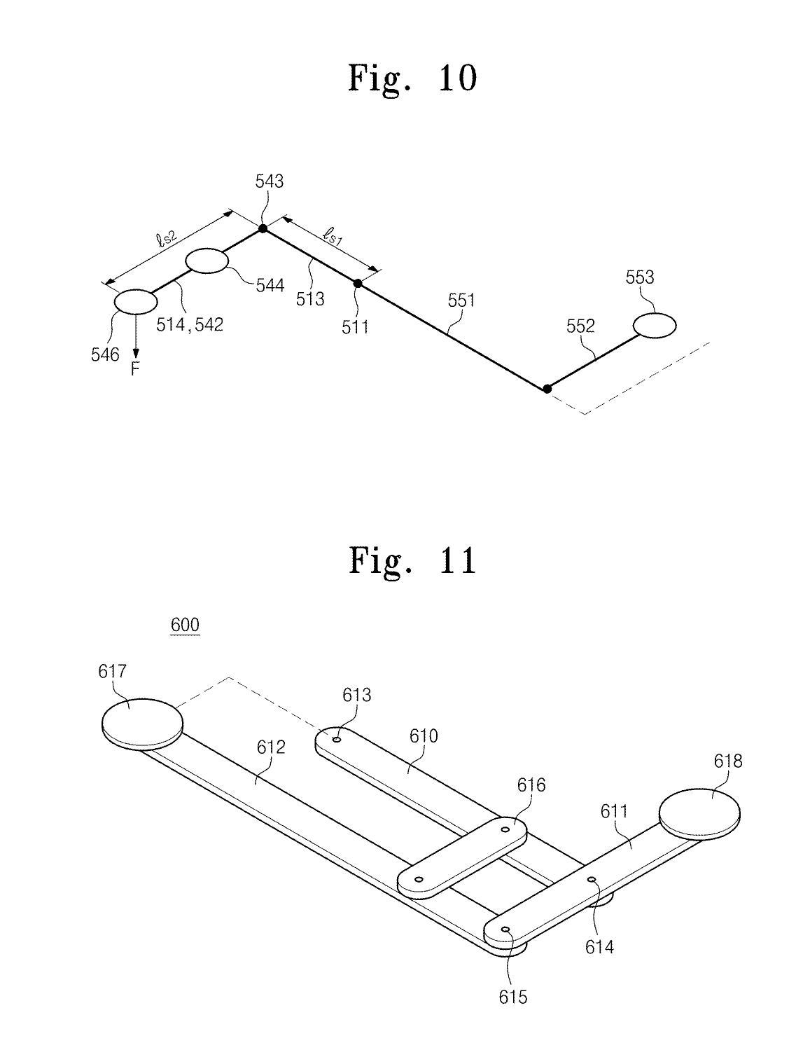

FIG. 11 is a drawing illustrating a multi-jointed arm having a compensation unit, according to another example embodiment of the inventive concepts.

Referring to FIG. 11, a first joint 613 is located at one end of a first link 610. The other end of the first link 610 is rotatably combined with one point of a second link 611 at a second joint 614. A working member 618 may be located at an end portion of the second link 611. The working member 618 may be omitted. A compensation link 612 is located in parallel to the first link 610. A length of the compensation link 612 is greater than a length of the first link 610. One end of the compensation link 612 is located adjacent to the second joint 614 and the other end of the compensation link 612 and the second link 611 are on opposite sides of the first joint 613. A compensation load 617 is located at the other end of the compensation link 612. The compensation link 612 and the compensation load forms a compensation unit. One end of the compensation link 612 is rotatably connected to one end of the second link 611 at the compensation joint 615. A location moving member 616 is provided between the first link 610 and the compensation link 612. The location moving member 616 parallelizes the compensation link 612 and the first link 610 even when the first link 610 and the second link 611 rotate. The location moving member 616 may be provided by a connection part 616. One point of the first link 610 and one point of the compensation link 612 are connected to the connection link 616. The connection link 616 is parallel to the second link 611. A line connecting both ends of the connection link 616, the second joint 614 and the compensation joint 615 form a parallelogram even when the second link 611 rotates.

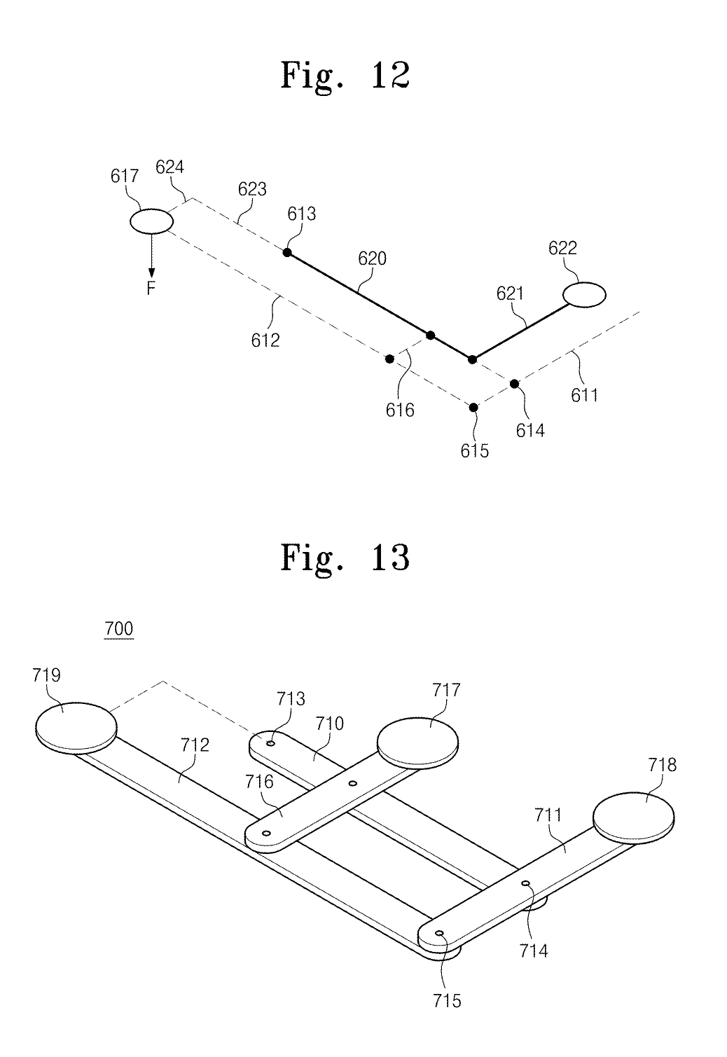

FIG. 12 is a schematic diagram of the multi-jointed arm of FIG. 11, according to an example embodiment of the inventive concepts.

Referring to FIG. 12, the multi-jointed arm 600 of FIG. 11 may be converted into an equivalent model. A first equivalent link 620, a second equivalent link 621 and equivalent mass 622 may be obtained by the processes as described above with respect to FIGS. 1-3. A first virtual line 623 extends in an opposite direction to the first equivalent link 620 at the first joint 613. The first virtual line 623 is parallel to the compensation link 612. The sum of a length of the first virtual line 623 and a length of the first link 610 is the same as a length of the compensation link 612. A second virtual line 624 connects an end portion of the first virtual line 623 and an end portion of the compensation link 612. Both ends of the second virtual line 624, the second joint 614 and the compensation joint 615 form a parallelogram. Even when the second link 611 rotates, the second virtual line 624 is parallel to the second link 611. The first virtual line 623 and the second virtual line 624 may be obtained by the mathematical formula 13 or the mathematical formula 14. The compensation load 617 is located at an end portion of the second virtual line 624.

FIG. 13 is a drawing illustrating a multi-jointed arm having a compensation unit, according to another example embodiment of the inventive concepts.

Referring to FIG. 13, a first link 710 rotates using a first joint 713 as a rotation axis. A connection relation of the first link 710, a second link 711 and a compensation link 712 is the same or similar to compensation link 612 of FIG. 11 and descriptions thereof are omitted. A compensation load 719 is located at an end portion of the compensation link 712. The compensation load 719 and the compensation link 712 form a compensation unit. A center of gravity of a connection link 716 is rotatably connected to the first link 710 and one end of the connection link 716 is rotatably connected to the compensation link 712. Auxiliary mass 717 is located at the other end of the connection link 716. The connection link 716 is parallel to the second link 711. A line connecting a part of the connection link 716, a second joint 714 and an auxiliary joint 715 forms a parallelogram even when the second link 711 rotates.

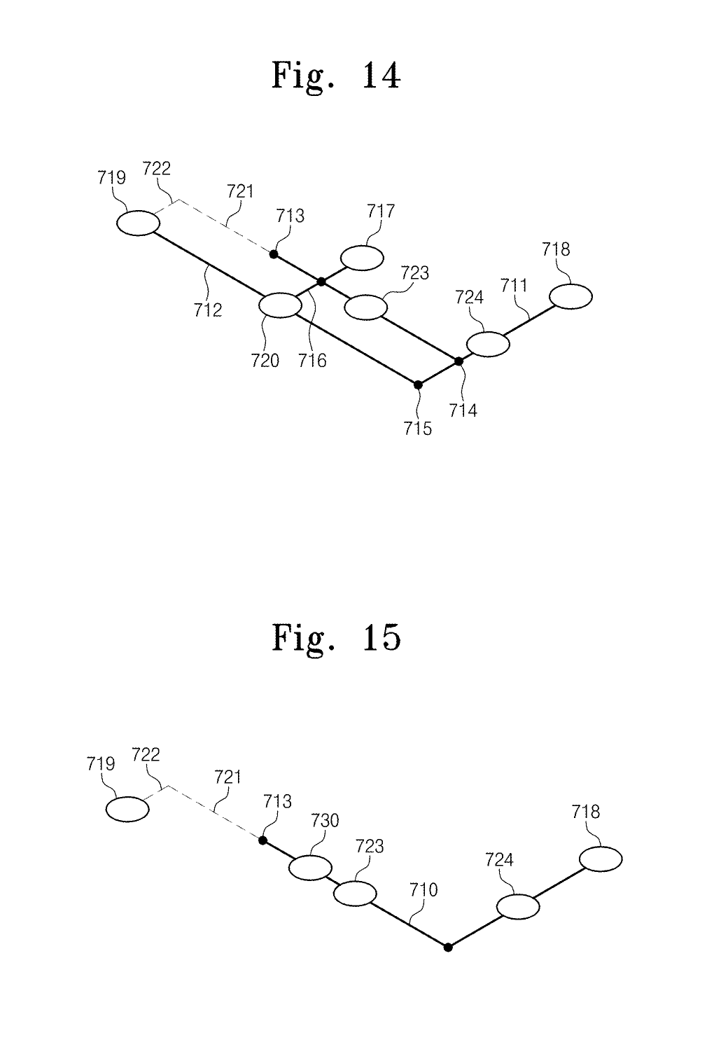

FIG. 14 is a drawing illustrating an equivalent model of FIG. 13, according to an example embodiment of the inventive concepts.

Referring to FIG. 14, one end of the connection link 716 is connected to a center 720 of gravity of the compensation link 712. The magnitude of the auxiliary mass may be the same as mass of the compensation link 712. The sum of the mass of the compensation link 712, the mass of the connection link 716 and the auxiliary mass 717 may be auxiliary equivalent mass (e.g., equivalent mass 730 of FIG. 15). Since a first virtual line 721 and a second virtual line 722 are the same or similar to the first virtual line 623 and the second virtual line 624 of FIG. 12, descriptions thereof are omitted.

FIG. 15 is a drawing illustrating an equivalent model of FIG. 14, according to an example embodiment of the inventive concepts.

Referring to FIG. 15, the auxiliary equivalent mass 730 is located on the first link 710. The auxiliary equivalent mass 730 and mass 723 of the first link 710 correspond to mass of the first line 310 of FIG. 2. Mass 724 of the second link 711 corresponds to mass of the second link 320 of FIG. 2. Mass of a working member 718 corresponds to mass of the working member 323 of FIG. 2. Thus, according to processes as described above with respect to FIGS. 2-4, a length of the first virtual line 721, a length of the second virtual line 722 and the magnitude of compensation load 719 can be obtained.

The above-disclosed subject matter is to be considered illustrative, and not restrictive, and the appended claims are intended to cover all such modifications, enhancements, and other embodiments, which fall within the true spirit and scope of the inventive concepts. Thus, to the maximum extent allowed by law, the scope of the inventive concepts is to be determined by the broadest permissible interpretation of the following claims and their equivalents, and shall not be restricted or limited by the foregoing detailed description.

1. An apparatus having a multi-jointed arm comprising:
a body;
a multi-jointed arm including a first link and a second link, the first link rotatably combined with the body at a first joint, and the second link rotatably combined with the first link at a second joint; and
a compensator configured to generate a compensation moment that reduces a moment being generated by a weight of the multi-jointed arm,
the compensator including,
a compensation load configured to generate the compensation moment; and
a compensation link that connects the compensation load and the multi-jointed arm such that the compensation load and the multi-jointed arm are on opposite sides of the first joint.

2. The apparatus having a multi-jointed arm of claim 1, further comprising:
the first link having a first virtual line extending in an opposite direction to the first link at the first joint, and
the compensation link having a second virtual line extending to the compensation load, the second virtual line configured to rotate with respect to the first virtual line at an end portion of the first virtual line, the compensation load being located at an end portion of the second virtual line.

3. The apparatus having a multi-jointed arm of claim 2, wherein
the first link and the second link are configured such that (i) a first angle is formed between the first link and the second link, (ii) a second angle is formed between the first virtual line and the second virtual line, and (iii) the first angle equals the second angle.

4. The apparatus having a multi-jointed arm of claim 2, wherein the first virtual line and the first link are in a straight line, and when the second link rotates with respect to the first link, the second virtual line rotates at the same angle and in the same direction as the second link with respect to the first virtual line.

5. The apparatus having a multi-jointed arm of claim 2, wherein the multi-jointed arm is converted into a virtual equivalent model, the model comprising:
a first equivalent link configured such that (i) a third angle is formed between the first equivalent link and the first link, and (ii) the third angle is equal to a fourth angle that is formed between the first link and the body,
a second equivalent link configured such that (i) a fifth angle is formed between the second equivalent link and the second link, and (ii) the fifth angle is equal to a sixth angle that is formed between the second link and the first link,
an equivalent mass having the same mass as the multi-jointed arm, the equivalent mass being located at an end portion of the second equivalent link, and
a connector connecting the end portion of the second virtual line and an end portion of the second equivalent link, the connector being adjacent to the first joint.

6. The apparatus having a multi-jointed arm of claim 5, wherein (i) the multi-jointed arm is configured such that a length of the first virtual line is proportional to a length of the second virtual line, (ii) the model is configured such that a length of the first equivalent link is proportional to a length of the second equivalent link, and (iii) a ratio of a length of the first virtual line to a length of the second virtual line is the same as a ratio of the length of the first equivalent link to the length of the second equivalent link.

7. The apparatus having a multi-jointed arm of claim 5, wherein (i) the multi-jointed arm is configured such that the compensation load is proportional to a weight of the multi-jointed arm, (ii) the model is configured such that a length of the first equivalent link is proportional to a length of the first virtual line, and (iii) a ratio of the compensation load to the weight of the multi-jointed arm is the same as a ratio of the length of the first equivalent link to the length of the first virtual line.

8. The apparatus having a multi-jointed arm of claim 5, wherein (i) the multi-jointed arm is configured to such that a weight of the compensation load is proportional to a weight of the multi-jointed arm, (ii) the model is configured to such that a length of the end portion of the second equivalent link to the first joint is proportional to a length of the end portion of the second virtual line to the first joint, and (iii) a ratio of weight of the compensation load to a weight of the multi-jointed arm is the same as a ratio of the length of the end portion of the second equivalent link to the first joint and the length of the end portion of the second virtual line to the first joint.

9. The apparatus having a multi-jointed arm of claim 1, wherein the compensation link comprises:
a first compensation link which extends in an opposite direction to the first link at the first joint,
the first link is configured to rotate at a seventh angle with respect to the first joint, the first compensation link is configured to rotate at an eighth angle with respect to the first joint, and the seventh angle is equal to the eighth angle; and
a second compensation link rotatably combined with the first compensation link at a compensation joint, the second compensation link including,
a first rotation body configured to rotate together with the second link at the second joint,
a second rotation body configured to rotate together with the second compensation link at the compensation joint, and
a location moving member connecting the first rotation body and the second rotation body such that the second rotation body and the second compensation link are configured to rotate in the same direction as the second link.

10. The apparatus having a multi-jointed arm of claim 1, wherein the compensation link is located parallel to the first link such that one end of the compensation link is adjacent to the second joint, an other end of the compensation link and the second link each being on opposite sides of the first joint, and
a connection link is provided between the compensation link and the first link, an end of the connection link being rotatably combined with the compensation link, and an other end of the connection link being rotatably combined with the first link.

11. The apparatus having a multi-jointed arm of claim 1, wherein the first joint includes a first actuator that provides power for the first link to rotate with respect to the body, and the second joint includes a second actuator that provides power for the second link to rotate with respect to first link.

12. The apparatus having a multi-jointed arm of claim 1, wherein the compensator is configured to generate a compensation moment that cancels out the moment being generated by the weight of the multi-jointed arm.

13.-20. (canceled)
